(19) United States
(12) Patent Application Publication
(10) Pub. No.: US 2005/0164750 A1
(43) Pub. Date: Jul. 28, 2005

(54) Mobile communication device with battery strap

(75) Inventor: Pagy Cheng, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Arima Communication Corp., Taipei (TW)

(21) Appl. No.: 10/762,902

(22) Filed: Jan. 22, 2004

(51) Int. Cl. H04M 1/00

(52) U.S. Cl. 455/575.1

(57) ABSTRACT

A mobile communication device with a battery strap is provided. The mobile communication device with a battery strap includes a main device; and a battery strap electrically connected to the main device for providing a battery power to the main device and worn by a user.

### FIELD OF THE INVENTION

The present invention is related to a mobile communication device, and more particularly, to a mobile communication device with a battery strap.

### BACKGROUND OF THE INVENTION

In recent years, a variety of Information Appliances (IAs) such as mobile phones, laptop computers have been prosperously developed. The latest design is developed with the features of compact size, light-weight, and high quality. Therefore, the volume and the location of the power supply are getting more and more important.

Li-ion secondary batteries which have advantages of high operating voltage (3.7 volt), high volumetric energy density, light-weight and long lifespan are largely applied to various of handheld and portable devices including laptop computers, PDAs, mobile phones as a power source. The latest generation of communication devices owning the functions of computers, PDAs, mobile phones emphasize not only its cordless and portable features, but also the feature of being worn around the wrist. Therefore, the requirements for the Li-ion battery as the power source of the 3G mobile phone or mobile IA are high energy, and even light and thin. The needed number of such battery is getting increasing in the market while the application of the mobile device is getting developed.

Furthermore, as the mobile phone is getting popular, people are used to getting a time from the mobile phone. So the watch is replaced by the mobile phone gradually. However, since the watch is worn around the wrist directly, obviously it is more convenient and portable than the conventional mobile phone does when the user wants to know the time. Additionally, in the conventional mobile phone, strict limits are placed upon the miniaturization process due to the volume of the battery which is integrated in the mobile phone. Also, if a mobile phone is dropped due to careless handling or accidentally impacted with something, the mobile phone is likely to be damaged and rendered useless. Hence, the conventional mobile phones have defects that portability is deteriorated due to the above reasons.

### SUMMARY OF THE INVENTION

It is the main object of the present invention to provide a mobile communication device with a battery strap.

It is another object of the present invention to provide a mobile communication device which can be adapted to the wrist and forearm of the wearer and which can be simply and comfortable used. Further, the mobile communication device of the invention weights as little as possible and possesses an alarm system.

According to one aspect of the present invention, the mobile communication device with a battery strap includes a main device; and a battery strap electrically connected to the main device for providing a battery power to the main device and worn by a user.

Preferably, the main device includes a display and a keyboard.

Preferably, the main deice is a wireless phone.

Preferably, the keyboard is arranged around the main device.

Preferably, the battery strap is flexible.

Preferably, the battery strap is a rechargeable battery.

Preferably, the main device further includes a power jack for charging the battery strap.

Preferably, the power jack is a phonejack.

Preferably, the mobile communication device further includes a headset.

Preferably, the headset is a wireless headset.

According to another aspect of the present invention, the mobile communication device with a battery strap includes a main device; a cover having a connecting portion connected to the main body; and a battery strap electrically connected to the main body for providing a battery power to the main device and worn by a user.

Preferably, the main device includes a keyboard.

Preferably, the main device is a wireless phone.

Preferably, the cover further includes a display.

Preferably, each of two surfaces of the cover includes a display.

Preferably, the battery strap is flexible.

Preferably, the battery strap is a rechargeable battery.

Preferably, the main device further includes a power jack for charging the battery strap.

Preferably, the power jack is a phonejack.

Preferably, the mobile communication device further includes a headset.

Preferably, the headset is a wireless headset.

The foregoing and other features and advantages of the present invention will be more clearly understood through the following descriptions with reference to the drawings, wherein:

### BRIEF DESCRIPTION OF THE DRAWINGS

FIG. 1 illustrates a mobile communication device with a battery strap according to a preferred embodiment of the present invention; and

FIG. 2 illustrates a mobile communication device with a battery strap according to another preferred embodiment of the present invention.

### DETAILED DESCRIPTION OF THE PREFERRED EMBODIMENT

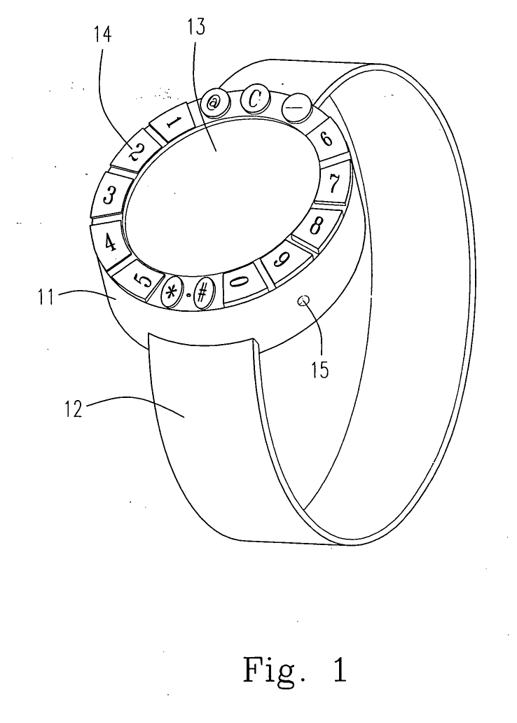

The present invention will now be described more specifically with reference to the following embodiment. Please refer to FIG. 1. FIG. 1 illustrates a mobile communication device with a battery strap according to a first preferred embodiment of the present invention. The mobile communication device includes the main device 11 and the battery strap 12. The main device 1 may be a mobile phone and has the screen 13 and the keypad 14. The keypad 14 is arranged around the periphery of the screen 13. The battery strap 12 is electrically connected to the main device 1 for being worn on a user's wrist. Further, the battery strap 12 is a rechargeable battery which can be charged repeatedly to power the main device 11 and is composed of a flexible material so as to wrap the user's wrist smoothly when properly bended. Also, the main device 11 further includes a power jack 15 for charging the battery strap 12 which is also a phonejack for communicating with a headset (not shown).

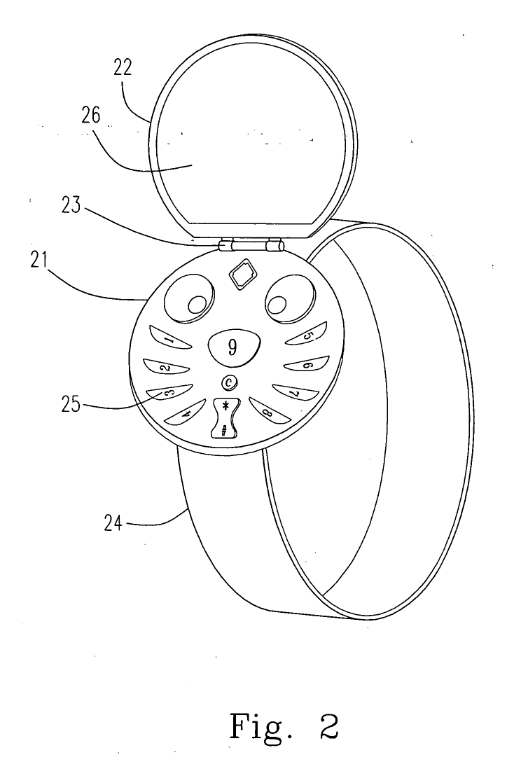

Referring to FIG. 2. FIG. 2 illustrates a mobile communication device with a battery strap according to a second preferred embodiment of the present invention. The mobile communication device includes the main device 21, the cover 22, and the battery strap 24. The main device 21 has the keypad 25. The keypad 25 is arranged on the surface of the main device 21. The cover 22 has a screen 26 and a connecting portion 23 so that the cover 22 can be folded on the main device 21. Also, the other surface of the cover 22 further includes a second screen (not shown) for showing messages. The structure and functions of the battery strap 24 is the same as mentioned above.

According to the above, because the cell phone can be worn on a user's wrist, it is very convenient to use and has the features of portability as well. Also, a digital camera can be integrated in the communication device of the present invention, in such a way, the main device will integrate a watch, a mobile phone, and a digital camera into one. That will highly increase the applications of the communication device of the present invention. Besides, the main device is powered by the battery strap, the main device can be made into one with lighter weight and compact size so as to decrease power consumption. Furthermore, the technology of the battery strap used in the present invention has been developed for a long time, so it doesn't raise much cost to produce the communication device of the invention.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. According, the invention is not limited by the disclosure, but instead its scope is to be determined entirely by reference to the following claims.

1. A mobile communication device with a battery strap, comprising:
a main device; and
a battery strap electrically connected to said main device for providing a battery power to said main device and worn by a user.

2. The device according to claim 1, wherein said main device comprises a display and a keyboard.

3. The device according to claim 1, wherein said main deice is a wireless phone.

4. The device according to claim 2, wherein said keyboard is arranged around said main device.

5. The device according to claim 1, wherein said battery strap is flexible.

6. The device according to claim 1, wherein said battery strap is a rechargeable battery.

7. The device according to claim 1, wherein said main device further comprises a power jack for charging said battery strap.

8. The device according to claim 7, wherein said power jack is a phonejack.

9. The device according to claim 1, wherein said mobile communication device further comprises a headset.

10. The device according to claim 9, wherein said headset is a wireless headset.

11. A mobile communication device with a battery strap, comprising:
a main device;
a cover having a connecting portion connected to said main body; and
a battery strap electrically connected to said main body for providing a battery power to said main device and worn by a user.

12. The device according to claim 11, wherein said main device comprises a keyboard.

13. The device according to claim 11, wherein said main device is a wireless phone.

14. The device according to claim 11, wherein said cover further comprises a display.

15. The device according to claim 11, wherein each of two surfaces of said cover comprises a display.

16. The device according to claim 11, wherein said battery strap is flexible.

17. The device according to claim 11, wherein said battery strap is a rechargeable battery.

18. The device according to claim 11, wherein said main device further comprises a power jack for charging said battery strap.

19. The device according to claim 18, wherein said power jack is a phonejack.

20. The device according to claim 11, wherein said mobile communication device further comprises a headset.

21. The device according to claim 20, wherein said headset is a wireless headset.
